(19) United States
(12) Patent Application Publication
(10) Pub. No.: US 2018/0010882 A1
(43) Pub. Date: Jan. 11, 2018

(54) LATERAL FIREARM CAMERA

(71) Applicant: PERIPHERAL OPTICS, LLC, Coral Springs, FL (US)

(72) Inventors: John Steven Soltys, Falls Church, VA (US); Robert N. Nicholson, Coral Springs, FL (US)

(73) Assignee: PERIPHERAL OPTICS, LLC, Coral Springs, FL (US)

(21) Appl. No.: 15/545,584

(22) PCT Filed: Nov. 23, 2015
(86) PCT No.: PCT/US15/62085

§ 371 Date: Jul. 21, 2017

(51) Int. Cl. F41C 27/00; H04N 5/232; H04N 5/225; H04N 5/247

(52) U.S. Cl. CPC F41C 27/00; H04N 5/23293; H04N 5/2252; H04N 5/247

(57) ABSTRACT

In combination with a hand-held firearm comprising a barrel having a longitudinal axis and a muzzle disposed at a distal end of the barrel, the improvement including a secondary viewing device with a housing coupled to the barrel of the firearm and having a first camera retained by, and disposed on a first side of, the housing of the secondary viewing device, disposed substantially adjacent to the muzzle of the firearm, and directed in a viewing orientation substantially orthogonal to the longitudinal axis of the barrel of the firearm for viewing targets lateral to the firearm, the secondary viewing device and the firearm operably configured to have simultaneous and omnidirectional rotation with one another by a user.

### FIELD OF THE INVENTION

The present invention relates generally to secondary bilateral viewing devices for hand-held firearms and, more particularly, relates to a firearm camera used for observing around objects.

### BACKGROUND OF THE INVENTION

Weapons, specifically hand-held firearms, are used by many people for a variety of reasons, including hunting, sport, combat, personal protection, games, and law enforcement. Secondary viewing devices are well-known in the field of firearms. The viewing devices are “secondary” in that the user's eyes are “primary.” Because of user-visibility limitations or to gain better focus on a particular target, many users utilize secondary viewing devices, e.g., telescopic sights or cameras. While these secondary viewing devices provide numerous advantages to the user in terms of target visibility and alignment, most lack the ability for the user to effectively and safely view targets around a corner or otherwise blocked by an object. Whether in combat, law enforcement, sports, e.g., paintball, or other areas, seeing around objects has become extremely desired by many firearm users.

As discussed, most known secondary devices are operable to only view objects directly in front of, and aligned with, the barrel of the firearm. As such, to view a potential target around the corner of an object such as a wall, i.e., out of the user's “line of sight,” the user is required to either (1) stick his or her head around the wall, (2) used a secondary viewing apparatus not associated with a firearm, e.g., a periscope or mirror, or (3) use those known secondary viewing apparatuses associated with firearms which generally require the barrel of the firearm to be substantially exposed beyond the corner or other obstacle. Option 1 has its obvious safety issues that will not be discussed. Option 2 appears significantly safer than Option 1, but creates its own set of safety concerns as the user is generally required to either set down the firearm or place it in an “unready” position, leaving him or her vulnerable to attack by a hostile target. In that vein, Option 2 is also a less efficient option. Option 3, while more desirable and safer than Options 1 and 2, is also unsafe as those known devices still require the user to partially place his or herself and/or the firearm in a position substantially exposed to the target in order to obtain a view of the target and the surrounding environment.

Two such devices incorporating the strategy of Option 3 include U.S. Pat. No. 6,543,173 (“Golan”) and U.S. Pat. No. 6,729,223 (“Lapasse”). One applicable embodiment of the invention in Golan involves a firearm assembly for shooting projectiles around a corner of an object. To accomplish this purpose, the firearm has a barrel portion pivotable with respect to a stock portion of the firearm. The barrel portion of the firearm is able to be pivoted 90° and has a viewing apparatus for solely viewing objects disposed in front of the muzzle of the barrel. Golan also discloses the use of pinhole cameras in either side of the stock section of the firearm to increase the field of view. This design, however, has several significant disadvantageous. First, if the viewing apparatus disposed on the barrel portion is used to look around objects, the barrel portion must be rotated substantially 90° relative to the stock portion. This partially, but substantially, exposes the firearm to the hostile target and, more importantly, also requires the user to unsafely reach around the corner to pull the trigger on the barrel portion. Golan also discloses mechanically coupling the trigger on the barrel to the trigger on the stock portion of the firearm through use of a cable. This, however, would problematically require the user to withstand substantial amounts of torque caused by the recoil of the firearm after discharged in said pivoted orientation, as well as possible unintentional firing of the gun if the cable is accidentally pulled. Further, if the user should desire to use the pinhole cameras disclosed in Golan—which only discusses it being located on one side of the firearm—to view around corners, the user is unsafely required to place a substantial portion of the firearm in the visibility range of the target in order to obtain a view of the target and the surrounding environment. In addition, if the target jumps around the corner while the gun in Golan is turned 90°, the user of the gun would have to somehow shoot the assailant with the while pointing the main stock of the gun 90° from the assailant. This would have a high probability of shooting unintended persons in the vicinity. Otherwise, the user of the gun would have to realign the gun in the heat of combat, leaving the user exposed and in danger for precious seconds before the gun could be fired normally. This presents an extreme danger and should be avoided.

Lapasse involves the disclosure of an observation means attached to the end of a cannon of an armored vehicle. Specifically, the purpose behind the invention in Lapasse was to provide users inside and completely shielded by an armored vehicle the ability to observe the ambient environment outside the armored vehicle. This purpose of Lapasse was not intended for users of hand-held firearms to observe around corners and other objects, regardless of the placement, orientation, or shape of said corners or objects. Said another way, the device in Lapasse is specifically limited providing three different cameras, each orientated “to cover a field of observation of approximately 180°.” Said even further, Lapasse is not concerned with, nor directed to, minimizing the visibility of the cannon as it projects around corners, nor would it be capable to moving any direction desired by the user because of some of the orientation and translation constraints on the cannon of a tank. Therefore, the disclosure in Lapasse would not provide motivation, nor the capability, for a person of ordinary skill in art to engage targets around a corner or object in a safe and effective manner, regardless the placement, orientation, or shape of said corners or objects, e.g., when entering an attack or manhole.

Therefore, a need exists to overcome the problems with the prior art as discussed above.

### SUMMARY OF THE INVENTION

The invention provides a bilateral firearm camera that overcomes the hereinafore-mentioned disadvantages of the heretofore-known devices and methods of this general type and that provides a device for effectively and safely viewing targets and other things around a corner of an object with a hand-held firearm, or around simultaneous corners, such as a T hallway. Specifically, present invention permits users to minimize or eliminate visibility of the firearm to a potentially hostile target, yet still obtain accurate images of the target and surrounding environment in a safe, quick, and effective manner.

With the foregoing and other objects in view, there is provided, in accordance with the invention and, in one embodiment, in combination with a hand-held firearm comprising a barrel having a longitudinal axis and a muzzle disposed at a distal end of the barrel, an improvement is disclosed that includes a secondary viewing device with a housing coupled to the barrel of the firearm. The secondary viewing device has a first camera retained by, and disposed on a first side of, the housing of the secondary viewing device, disposed substantially adjacent to the muzzle of the firearm, and directed in a viewing orientation substantially orthogonal to the longitudinal axis of the barrel of the firearm for viewing targets lateral to the firearm, the secondary viewing device and the firearm operably configured to have simultaneous and omnidirectional rotation with one another by a user.

In accordance with a further feature of the present invention, the first camera is disposed in front of the muzzle of the firearm.

In accordance with another feature, an embodiment of the present invention includes a display communicatively coupled to the first camera and operably configured to receive an image corresponding to the viewing orientation of the first camera. The display may also be communicatively coupled to the first and second cameras, as discussed herein, and operably configured to receive a plurality of images corresponding, respectively, to the viewing orientations of both the first and second cameras.

In accordance with an additional feature, another embodiment of the present invention includes a second camera retained by, and disposed on a second side of, the housing of the secondary viewing device, disposed substantially adjacent to the muzzle of the firearm, and directed in a viewing orientation substantially orthogonal to the longitudinal axis of the barrel of the firearm for viewing targets lateral to the firearm, wherein the viewing orientation of the second camera of a substantially inverse orientation with respect to the viewing orientation of the first camera.

In accordance with yet another feature, an embodiment of the present invention also includes a sleeve defining an opening sized and shaped to receive a user's arm and having an outer surface with the display coupled thereto, wherein the display operably configured to simultaneously display the plurality of images corresponding, respectively, to the viewing orientations of both the first and second cameras.

In accordance with an additional feature, an embodiment of the present invention includes the housing of the secondary viewing device having a pivot member housing the first camera, the pivot member operably configured to pivot with respect to the housing from a first lateral position along a camera translation path with the first camera directed in the viewing orientation substantially orthogonal to the longitudinal axis of the barrel of the firearm to a second lateral position along the camera translation path with the first camera directed in a second viewing orientation substantially orthogonal to the longitudinal axis of the barrel of the firearm and of a substantially inverse orientation with respect to the viewing orientation of the first camera in the first lateral position.

In accordance with a further feature of the present invention, the pivot member is operably configured to pivot with respect to the housing to a forward-facing position along the first camera translation path with the camera directed in a viewing orientation substantially parallel with the longitudinal axis of the barrel of the firearm. The forward-facing position may be aligned with the longitudinal axis of the barrel of the firearm.

In accordance with a further feature of the present invention, the housing of the secondary viewing device is coupled to the barrel of the firearm through a tongue-and-grove configuration.

In accordance with the present invention, another embodiment of a secondary viewing device for a firearm is disclosed that includes (1) a housing with a distal end, a proximal end, a first side, a second side opposing the first side of the housing, and an upper surface interposed between the first and second sides of the housing and having a track operably configured to removably couple the housing with a rail of a hand-held firearm, (2) a first camera retained by the housing, disposed substantially adjacent to the distal end of the housing, and directed in a viewing orientation projecting outwardly from the first side of the housing and substantially orthogonal to a longitudinal axis of the track of the housing for viewing targets lateral to a first side of the hand-held firearm, and (3) a second camera retained by the housing, disposed substantially adjacent to the distal end of the housing, and directed in a viewing orientation projecting outwardly from the second side of the housing and substantially orthogonal to a longitudinal axis of the track of the housing for viewing targets lateral to a second side of the hand-held firearm, the viewing orientation of the second camera of a substantially inverse orientation with respect to the viewing orientation of the first camera.

In accordance with the present invention, another embodiment of a secondary viewing device for a firearm, in combination with said hand-held firearm, is disclosed that includes a secondary viewing device with a housing removably coupled to the barrel of the firearm. The secondary viewing device has a first camera retained by, and disposed on a first side of, the housing of the secondary viewing device, disposed in front of the muzzle of the firearm, and directed in a viewing orientation substantially orthogonal to the longitudinal axis of the barrel of the firearm for viewing targets lateral to the firearm and a second camera retained by, and disposed on a second side of, the housing of the secondary viewing device, disposed in front of the muzzle of the firearm, and directed in a viewing orientation substantially orthogonal to the longitudinal axis of the barrel of the firearm for viewing targets lateral to the firearm, wherein the viewing orientation of the second camera of a substantially inverse orientation with respect to the viewing orientation of the first camera.

In accordance with a further feature of the present invention, the first and second cameras are disposed substantially adjacent to the muzzle of the hand-held firearm.

Although the invention is illustrated and described herein as embodied in a bilateral firearm camera, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the barrel of a firearm or weapon to which the secondary viewing device is attached. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is an elevational left side view of a hand-held firearm with a secondary viewing assembly coupled thereto in accordance with the present invention;

FIG. 2 is an elevational right side view of the firearm and secondary viewing apparatus of FIG. 1;

FIG. 3 is a perspective view of the firearm and secondary viewing apparatus of FIG. 1;

FIG. 4 is a perspective view of a user wearing a sleeve with a display for depicting images received by the second viewing apparatus of FIG. 1 in accordance with an exemplary embodiment of the present invention;

FIG. 5 is a block diagram of a communication/display network involving at least one camera on the secondary viewing device of FIG. 1 and at least one display in accordance with an embodiment of the present invention; and

FIG. 6 is a perspective view of a secondary viewing apparatus with a pivotable member housing a camera operable to pivot between lateral and forward-facing position in accordance with an exemplary embodiment of the present invention.

### DETAILED DESCRIPTION OF THE INVENTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient bilateral firearm camera for viewing objects around corners, hallways and other objects in an effective, safe, and efficient manner, while still maintaining effective functionality of the firearm itself. Embodiment of the present invention also provides a secondary viewing device removably coupleable to a hand-held firearm and operable to display those images received from the secondary viewing device to a user or multiple users over a network.

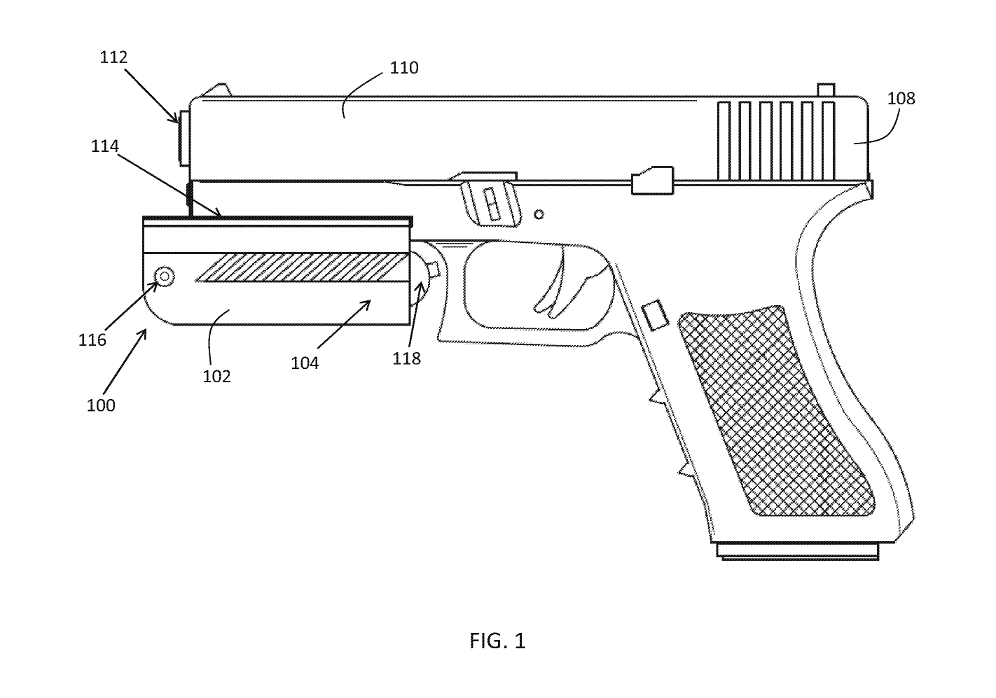

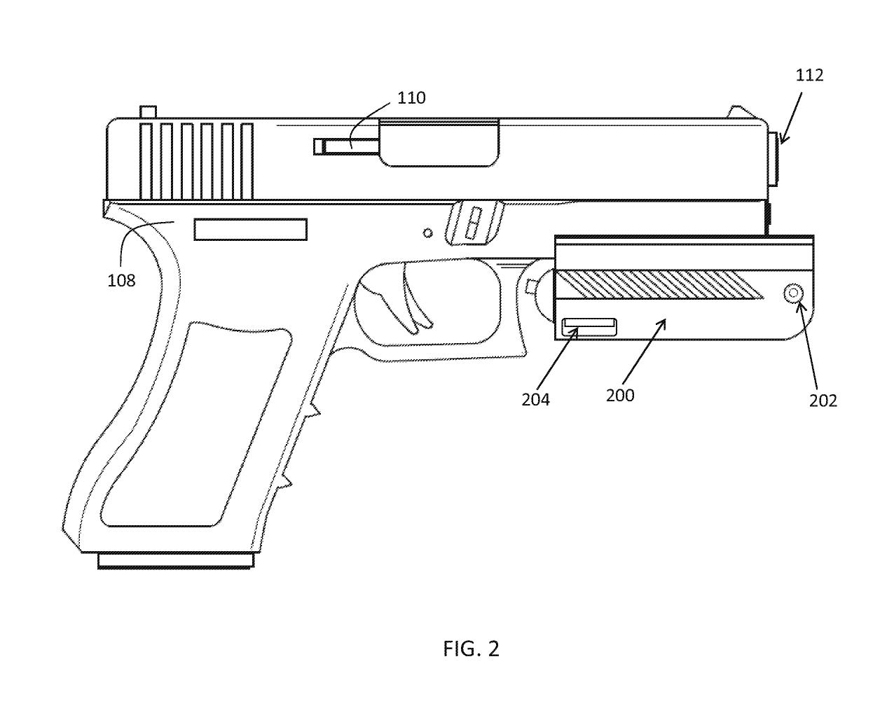

Referring now to FIGS. 1-3, one embodiment of the present invention is shown in side elevational views. FIGS. 1-3 show several advantageous features of the present invention, but, as will be described below, the invention can be provided in several shapes, sizes, combinations of features and components, and varying numbers and functions of the components. The first example of a secondary viewing device 100, as shown in FIGS. 1-3, includes a housing 102 of the viewing device 100 having a first side 104 and a second side 200 (see FIG. 2), wherein the secondary viewing device 100 be seen removably coupleable to a hand-held firearm 108. The firearm 108 is hand-held in that it is capable of being carried, moved, or operated by a user with his or her hands, and without the use of machinery, equipment, or other external devices. The hand-held firearm 108 can be a number of weapons such as a rifle, a shotgun, a handgun, a paint-ball gun, or, in other applications, a cross bow.

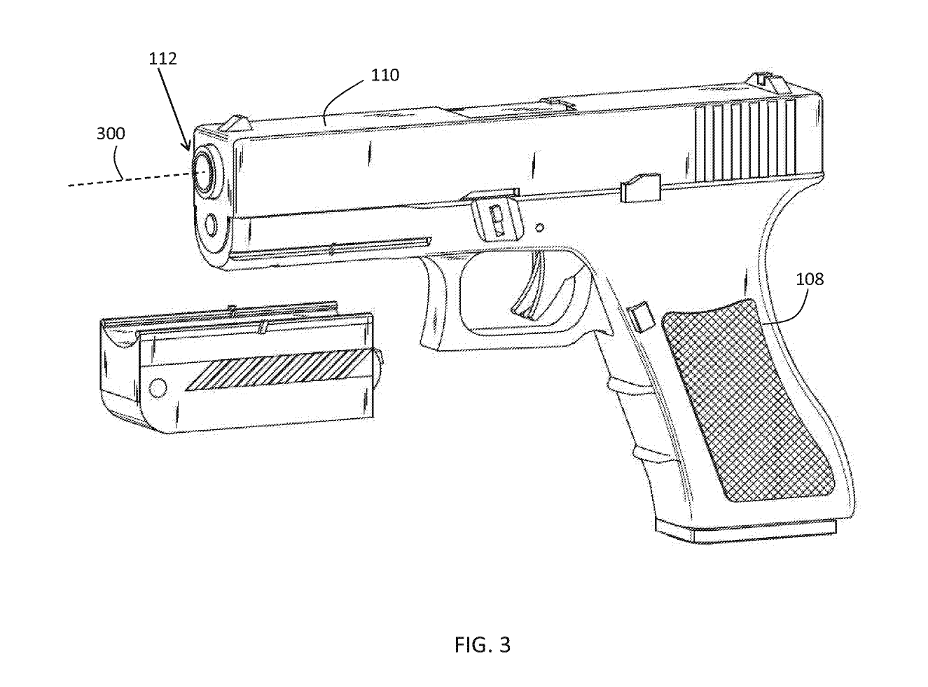

The firearm 108 generally includes a barrel 110 having a longitudinal axis (depicted in FIG. 3 as numeral 300) and a muzzle 112 (or open end of the barrel 110 of the firearm 108) disposed at a distal end of the barrel 110. The firearm 108 may also include a trigger, a rail 114, a slide, a stock, and other components known by those of skill in the art. Of note, the rail 114, or sometimes referred to a “guard rail,” typically includes a track or tongue-and-grove configuration that facilitates in engaging, securing, and removing the housing 102 of the secondary viewing device 100 to/from the firearm 108.

In line with one purpose of viewing objects and environments around corners and other objects, the viewing device 100 can advantageously be seen having a first camera 116 and/or a second camera 202 (see FIG. 2) retained by, and disposed on respective first and/or second sides 104, 200 of, the housing 102 of the secondary viewing device 100. In one embodiment, a single camera 116, i.e., the lens or other portion adapted to receive images, is disposed substantially adjacent to the muzzle of the firearm, and directed in a viewing orientation substantially orthogonal (90°+/−10°) to the longitudinal axis 300 of the barrel 110 for viewing targets lateral to the firearm 108. The secondary viewing device 100 and the firearm 108 are also operably configured to have simultaneous and omnidirectional rotation with one another by a user for quick and effective maneuverability to view targets around a corner. Said another way, the secondary viewing device 100 and firearm 108 are able to move with one another in any direction so as to maneuver the firearm 108 around any corner/object and in any orientation or angle.

In other embodiments, the secondary viewing device 100 has two cameras, e.g., the first and second cameras 116, 202, wherein the second camera 202 is also disposed substantially adjacent the muzzle 112 of the firearm 108, directed in a viewing orientation substantially orthogonal to the longitudinal axis 300 of the barrel 110, and of a substantially inverse orientation with respect to the viewing orientation of the first camera 116. As such, the second camera 202 is also operable to view targets lateral to the firearm 108, but it will be those targets placed in a direction away from the second side 200 and in a direction opposite to the first side 104. The term “substantially adjacent” is defined herein as sharing a border with or immediately following a border, i.e., within approximately 1-2″, of a surface or referenced area.

The housing 102 may of a cast or extruded metallic material such as aluminum. In other embodiments, the housing 102 may be of a ceramic, composite, polymeric, or other material that is substantially rigid so as to house the cameras 116, 202 and resist the forces generated from the operation of the firearm 108. The housing 102 may have pre-bored apertures sized and shaped to receive the cameras 116, 202 and may be pre-formed with a tongue-and-grove configuration for receiving/insertion into the rail of the firearm 108. In other embodiments, the housing 102 may be coupled to the firearm 108 with a strap or other fasteners.

In preferred embodiments, the first camera 116 and second camera 202 are also disposed in front of the muzzle 112 of the firearm 108 as shown in FIGS. 1-2. In other embodiments, the cameras 116, 202 are in front of, and substantially adjacent to, the muzzle 112. In further embodiments, the cameras 116, 202 are just substantially adjacent to the muzzle 112. As opposed to known devices, the advantageous placement of the cameras 116, 202 creates a secondary viewing device that effectively and safely locates targets and the environment around corners and objects.

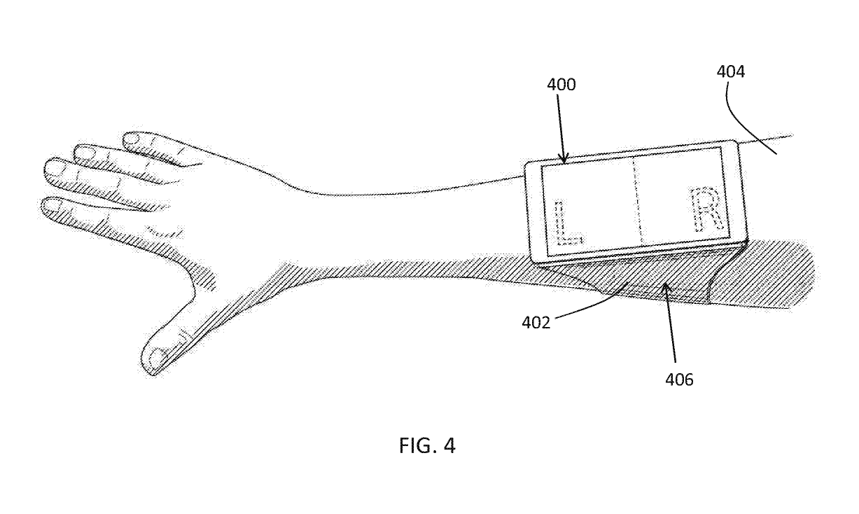

With reference now to FIGS. 3-4, to view the images received by the first and second cameras 116, 202, a display 400 may be utilized. The display 400 shown in FIG. 4 is communicatively coupled to the first and second cameras 116, 202 and operably configured to receive one or more images of the camera(s) 116, 202. The one or more images depicted by the display 400 correspond to the viewing orientations of both the first and second cameras 116, 202. FIG. 4 specifically depicts a sleeve 402 which defines an opening sized and shaped to receive a user's arm 404 and having an outer surface 406 with the display 400 coupled thereto. The sleeve 402 may be of a polymeric and elastic material such as neoprene, a fabric material such as nylon, or another material. In one embodiment, the opening of the sleeve 402 has a diameter of approximately 2.5-4″ in a static state, but may have a greater diameter in a dynamic state (i.e., when stretched if elastic). The sleeve 402 may also have ends that are removably coupleable with one another to form a tight fit around a user's arm 404 as shown in FIG. 4. While the display 400 is shown coupled on a sleeve 402, it may also be advantageously coupled, through one or more fasteners, to other clothing of a user, embedded into eyewear, or used in other applications.

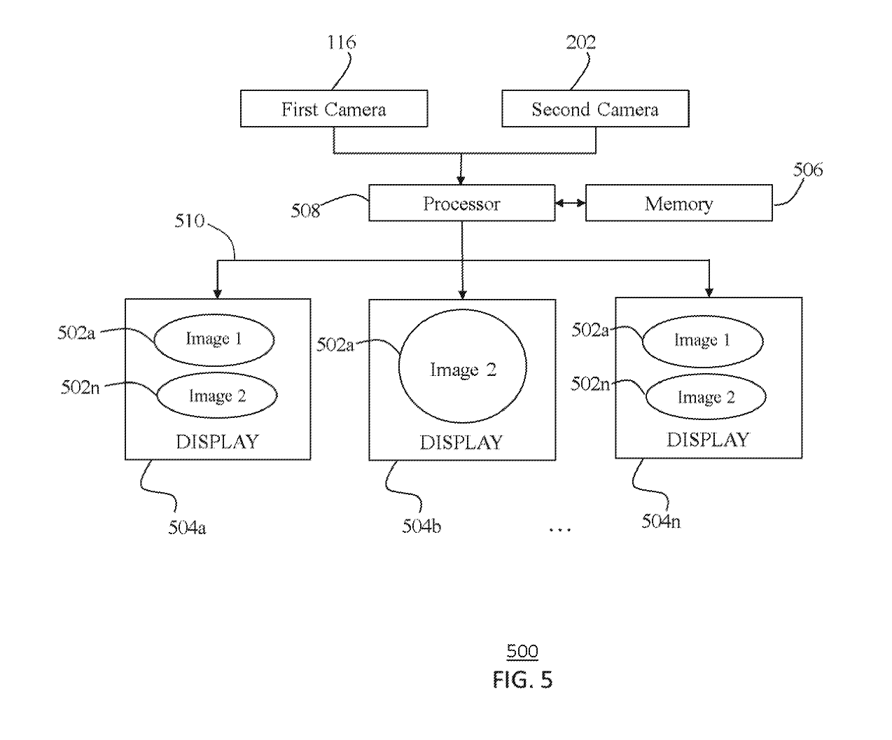

With reference now to FIG. 5, a block diagram depicting a communication network 500 over which the image(s) 502a-b from the camera(s) 116, 202 are communicated to one or more display(s) 504a-n is shown. The letter “n” used in “a-n” is any number greater than 1, but is no more than a number that is limited by the design constraints of the structure and/or system used by the present invention. The display(s) 504a-n are operably configured to display one or more images 502a-b that correspond to the viewing orientations of the one or more camera(s) 116, 202, respectively. When two cameras 116, 202 are utilized, the display(s) are operable to simultaneously display both viewing orientations, e.g., “left” and “right” sides of the device 100 and firearm 108, of the camera(s) 116, 202, as depicted in FIG. 4. The depicted communication network 500 not only advantageously permits the first-party user of the device 100 to view targets and environments around an object or corner, but it also permits third-party users to view the same. This is particularly beneficial in multi-party law enforcement or military raids where other team members, supervisors and command units may heavily rely on those images 502a-n received by the camera(s) 116, 202 to make decisions and determine strategies.

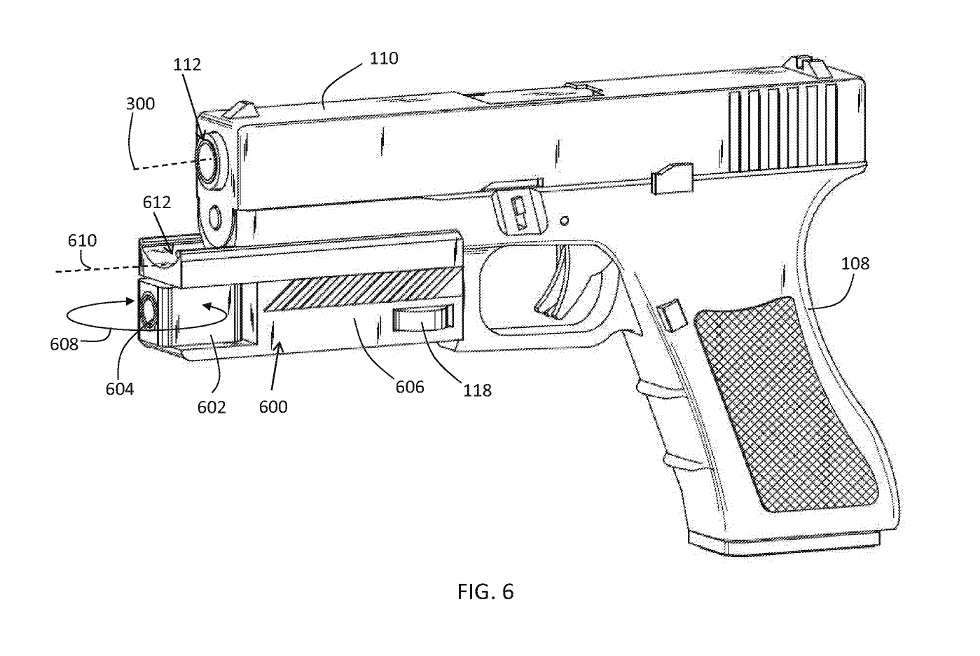

The camera(s) 116, 202 include those components known to those persons of skill in the art for generating one or more image(s) 502a-n of a target in an outside environment. These image(s) 502a-n may come in the form of video and photograph(s), and may be digital video when used with the display(s) 504a-n, may be infrared images, or other applications that depict and/or record visual perceptions received by the one or more camera(s) 116, 202. The camera(s) 116, 202 may be activated and/or powered using a toggle switch 118 disposed on the housing 102, wherein power may be supplied from a power source to the camera(s) 116, 202 upon the translation of the switch 118 so as to close or open an electrical circuit. The switch 118 may be vertically positioned or horizontally positioned. In further embodiments, the switch 118 may be of a ball-track configuration disposed on a side of the housing 102 (as shown in FIG. 6). The housing 102 may also include a USB charging port 204 (as shown in FIG. 2) for re-charging a power source electronically coupled to the camera(s) 116, 202. In other embodiments, the housing 102 may include one more openings for replaceable batteries.

The camera(s) 116, 202 may employ an aperture on the body of the camera, a shutter to initiate the image producing process, and may also include a flash bulb or light device that facilitates capturing an image of the target or ambient environment lateral to the firearm. The camera(s) 116, 202 may utilize the aperture size and shutter speed to focus light from the outside environment to a semi-conductor or film. The camera(s) 116, 202 may also utilize a shutter speed with a fixed focus or an optical zoom. When the light is directed to the semi-conductor, the image is produced through techniques known to those skilled in the art. The camera(s) 116, 202 may use a charge-coupled device [CCD], a complementary metal oxide semi-conductor [CMOS], or the like to receive the light from the outside environment. The camera(s) 116, 202 may utilize transistors, noise reducers, beam splitters, filters, or other components or features utilized in producing an image, specifically a digital image, without deviating from spirit and scope of the present invention.

In one embodiment, after the image(s) 502a-n have been created, they are stored internally or externally on a recording medium, i.e., memory 506, that is accessible through a computer means, i.e., a processor 508, or other device that has the ability to process data. The memory 506 may include, for example, flash memory devices, hard disk drive, circuitry with non-volatile RAM, disc storage, or the like. The image(s) 502a-n stored on the recording medium or other storing means may be accessible through the processor 508, such that the data, i.e., image, could be said to be a computer readable medium.

The display(s) 504a-n, as referred to herein, are output device(s) for presentation of information in visual, audio, or tactile form (the latter used for example in tactile electronic displays for blind people). The input to the display(s) 504a-n is a series of electronic signals that the display(s) 504a-n interprets and converts to visual, tactile, and/or auditory outputs. Common applications for electronic visual displays are television sets, computer monitors, or smart phones/tablets. So that each display 504a-n can relay information to the first- or third-party user, the display(s) 504a-n will be communicatively coupled to the processor 508.

In one embodiment, the display(s) 504a-n are hard-wired (depicted in FIG. 5 with communication lines 510) to the camera(s) 116, 202 when the display(s) 504a-n are located on the firearm 108 and/or the secondary viewing device 100. In other embodiments, what is depicted in FIG. 5 as lines 510 are actually wireless communication channels that, through known protocols, wirelessly couple the display(s) 504a-n to the camera(s) 116, 202. As such, the network 500 may include one or more network interface cards (NIC) or a network controller. The wireless network 500 can include hardware and/or a computer program that is responsible for wireless communications. The wireless network interface may include an antenna. In one embodiment, the antenna is a radio frequency transmitter and/or receiver for transmitting and receiving radio frequency signals. In another embodiment, the antenna is a radio frequency transceiver. Although the wireless network 500 is discussed as providing for wireless communications, in some embodiments, the wireless network interface may also include hardware and/or software components configured to provide wired communications.

In further embodiments, the wireless network 500 may include a personal area network (PAN) interface. The PAN interface may provide the capability for the camera(s) 116, 202 to be communicatively coupled to the display(s) 504a-n using a short-range communication protocol, for example, a Bluetooth communication protocol. Bluetooth is an industrial specification for wireless PANs. Bluetooth provides a way to connect and exchange information between devices such as smartphones, laptops, PCs, printers, digital cameras, and video game consoles via an unlicensed, short range radio frequency. Bluetooth typically operates at a frequency of about 2.4 GHz. In order to use Bluetooth wireless technology, a device must be able to interpret certain predefined Bluetooth profiles. The profiles define the possible applications that work with the device. Bluetooth profiles define general behaviors through which Bluetooth-enabled devices communicate with other devices. Bluetooth technology defines a wide range of profiles that describe many different types of use cases.

The PAN interface may also permit wireless communication to other electronic devices (e.g., personal computer) via a peer-to-peer, ad hoc, connection. For example, in one embodiment, the wireless network 500 may include a Wi-fi interface that is configured to support short range, peer-to-peer ad hoc communications. Ad hoc networks allow devices to communicate directly with each other in a peer-to-peer configuration, without requiring an access point, such as a Wi-fi router. Additionally, the wireless network 500 may also include a local area network (LAN) interface. The LAN interface may be, for example, an interface to a wireless LAN, such as a Wi-fi network. The range of the LAN interface may generally exceed the range available via the PAN interface. Typically, a connection between two electronic devices via the LAN interface may involve communication through a network router or other intermediary device. More particularly, the wireless network 500 may include the capability to connect to a wide area network (WAN), such as the Internet, via an access point, such as a Wi-fi network router associated with a wireless LAN.

With reference now to FIG. 6, another advantageous embodiment of the secondary viewing device 600 is shown. Specifically, the device 600 is shown coupled to a firearm 108 as shown in FIGS. 1-3, but it now includes a pivot member 602 which now houses one or more camera(s) 604. The pivot member 602 is operably configured to pivot, i.e., rotate or slide, with respect to the housing 606 of the device 600 from (1) a first lateral position along a camera translation path (an exemplary path is depicted with numeral 608 in FIG. 6) with the camera 604 directed in the viewing orientation substantially orthogonal to the longitudinal axis 300 of the barrel 110 of the firearm 108 to (2) a second lateral position along the camera translation path 608 with the camera directed in a second viewing orientation substantially orthogonal to the longitudinal axis 300 of the barrel 110 and of a substantially inverse orientation with respect to the viewing orientation of the camera 604 in the first lateral position.

Said another way, one camera 604 is operable, in first position, to view a left lateral side of the firearm 108, while being operable, in a second position, preferably rotated 180° from the first position, to view a right lateral side of the firearm 108. This configuration provides a device 600 that can effectively adapt to viewing both lateral sides of the firearm in a cost-effective manner. It is limited, however, in that the user will not be able to visualize both lateral sides of the firearm simultaneously in real-time or near real-time. As such, the pivot member 602 may utilize two cameras positioned as described above and, because it is permitted to pivot, can be operably configured to pivot with respect to the housing to a forward-facing position (shown in FIG. 6) along the camera translation path 608 with the camera 604 directed in a viewing orientation substantially parallel (i.e., within +1-10° deviation) with the longitudinal axis 300 of the barrel 110 of the firearm 108. Said another way, one or more of the camera(s) 604 housed by the pivot member 602 may also be said to be directed in a viewing orientation substantially parallel with the longitudinal axis (depicted in FIG. 6 with numeral 610) of the track of the housing 606. The track be seen included on an upper surface 612 of the housing and is interposed between the first and second sides of the housing 606. The track is operably configured to removably couple the housing 606 with a rail of a hand-held firearm 108. This coupling configuration may be through a tongue-and-groove arrangement.

The forward-facing position may also be advantageously aligned with the longitudinal axis 300 of the barrel 110 of the firearm 108 for obtaining more accurate representation of what the firearm 108 is pointed toward. The maneuverability of the pivot member 602 permits the user to not only view targets lateral to the firearm 108, but it also permits the user to quickly convert the device 600 to view targets disposed in front of the firearm 108. This can be particularly advantageous in settings where third-party users are desirous to view all orientations of the firearm 108 by the first-party user of the device 600 or to utilize night vision capabilities contemplated by one embodiment of the present invention.

In one embodiment, the pivot member 602 is translated by the first-party user with his or hand and may be operable to lock into place in particular orientations, e.g., those parallel or orthogonal to the barrel 110 of the firearm 108. In other embodiments, the pivot member 602 is translated by the first-party user with a cable or rod that is coupled to the pivot member 602 so as enable the user to move the pivot member 602 without reaching in front of the muzzle 112 of the firearm 108. The cable or rod spans in a direction toward the trigger of the firearm 108 and is operable, upon subjected to a force by user, to move back-and-forth and/or side-to-side to translate the pivot member 602. In further embodiments, the pivot member 602 may be rotated electro-mechanically using servo motors communicatively coupled to a toggle switch.

For example, in one embodiment, the pivot member 602 has a 180° path of rotation 608 with 3 positions along that path 608. The first position reflects a 0° position (or “first viewing position”) wherein the camera 604 is directed in a viewing orientation projecting outwardly from the first side of the housing 606 and substantially orthogonal to a longitudinal axis 610 of the track of the housing 606 (which would also be substantially orthogonal to the barrel 110 of the firearm 108) for viewing targets lateral to a first side of the hand-held firearm 108 when the device 600 is coupled thereto. Next, the second position (or “forward facing position”) reflects a 90° rotation from the 0° position, wherein the camera 604 is directed in a viewing orientation substantially parallel to the longitudinal axis 610 of the track of the housing 606 (which would also be substantially parallel to the barrel 110 of the firearm 108) for viewing targets in front of the firearm 108 when the device 600 is coupled thereto. Next, the third position (or “third viewing position”) reflects a 180° rotation from the 0° position, wherein the camera 604 is directed in a viewing orientation projecting outwardly from the second side of the housing 606 and substantially orthogonal to a longitudinal axis 610 of the track of the housing 606 (which would also be substantially orthogonal to the barrel 110 of the firearm 108) for viewing targets lateral to a second side of the hand-held firearm 108 when the device 600 is coupled thereto.

A secondary viewing device has been disclosed that safely and effectively enables users to view targets and environments around corners and other objects using one or more camera(s), while still maintaining effective functionality of the firearm itself. The secondary viewing device also includes a housing that enables the secondary viewing device to be removably coupleable to a hand-held firearm and operable to display those images received from the camera(s) to one or more users.

What is claimed is:

1. In combination with a hand-held firearm comprising a barrel having a longitudinal axis and a muzzle disposed at a distal end of the barrel, the improvement comprising:
a secondary viewing device with a housing coupled to the barrel of the firearm, the secondary viewing device having a first camera retained by, and disposed on a first side of, the housing of the secondary viewing device, disposed substantially adjacent to, and in front of, the muzzle of the firearm, and directed in a viewing orientation substantially orthogonal to the longitudinal axis of the barrel of the firearm for viewing targets lateral to the firearm, the secondary viewing device and the firearm operably configured to have simultaneous and omnidirectional rotation with one another by a user.

2. (canceled)

3. The improvement according to claim 1, further comprising:
a display communicatively coupled to the first camera and operably configured to receive an image corresponding to the viewing orientation of the first camera.

4. The improvement according to claim 1, further comprising:
a second camera retained by, and disposed on a second side of, the housing of the secondary viewing device, disposed substantially adjacent to the muzzle of the firearm, and directed in a viewing orientation substantially orthogonal to the longitudinal axis of the barrel of the firearm for viewing targets lateral to the firearm, the viewing orientation of the second camera of a substantially inverse orientation with respect to the viewing orientation of the first camera.

5. The improvement according to claim 4, further comprising:
a display communicatively coupled to the first and second cameras and operably configured to receive a plurality of images corresponding, respectively, to the viewing orientations of both the first and second cameras.

6. The improvement according to claim 5, further comprising
a sleeve defining an opening sized and shaped to receive a user's arm and having an outer surface with the display coupled thereto, the display operably configured to simultaneously display the plurality of images corresponding, respectively, to the viewing orientations of both the first and second cameras.

7. The improvement according to claim 1, wherein the housing of the secondary viewing device further comprises:
a pivot member housing the first camera, the pivot member operably configured to pivot with respect to the housing from a first lateral position along a camera translation path with the first camera directed in the viewing orientation substantially orthogonal to the longitudinal axis of the barrel of the firearm to a second lateral position along the camera translation path with the first camera directed in a second viewing orientation substantially orthogonal to the longitudinal axis of the barrel of the firearm and of a substantially inverse orientation with respect to the viewing orientation of the first camera in the first lateral position.

8. The improvement according to claim 7, wherein:
the pivot member is operably configured to pivot with respect to the housing to a forward-facing position along the first camera translation path with the camera directed in a viewing orientation substantially parallel with the longitudinal axis of the barrel of the firearm.

9. The improvement according to claim 8, wherein:
the forward-facing position is aligned with the longitudinal axis of the barrel of the firearm.

10. The improvement according to claim 1, wherein:
the housing of the secondary viewing device is coupled to the barrel of the firearm through a tongue-and-grove configuration.

11. A secondary viewing device for a firearm comprising:
a housing with a distal end, a proximal end, a first side, a second side opposing the first side of the housing, and an upper surface interposed between the first and second sides of the housing and having a track operably configured to removably couple the housing with a rail of a hand-held firearm;
a first camera retained by the housing, disposed substantially adjacent to the distal end of the housing, and directed in a viewing orientation projecting outwardly from the first side of the housing and substantially orthogonal to a longitudinal axis of the track of the housing for viewing targets lateral to a first side of the hand-held firearm;
a second camera retained by the housing, disposed substantially adjacent to the distal end of the housing, and directed in a viewing orientation projecting outwardly from the second side of the housing and substantially orthogonal to a longitudinal axis of the track of the housing for viewing targets lateral to a second side of the hand-held firearm, the viewing orientation of the second camera of a substantially inverse orientation with respect to the viewing orientation of the first camera; and
a pivot member coupled to the housing, the pivot member housing the first camera and the second camera, and operably configured to pivot with respect to the housing to a forward-facing position along a camera translation path with at least one of the first camera and second camera directed in a viewing orientation substantially parallel with the longitudinal axis of the track of the housing.

12. The secondary viewing device according to claim 11, further comprising:
a display communicatively coupled to the first and second cameras and operably configured to receive a plurality of images corresponding, respectively, to the viewing orientations of both the first and second cameras.

13. The secondary viewing device according to claim 12, further comprising
a sleeve defining an opening sized and shaped to receive a user's arm and having an outer surface with the display coupled thereto, the display operably configured to simultaneously display the plurality of images corresponding, respectively, to the viewing orientations of both the first and second cameras.

14. (canceled)

15. In combination with a hand-held firearm comprising a barrel having a longitudinal axis and a muzzle disposed at a distal end of the barrel, the improvement comprising:
a secondary viewing device with a housing removably coupled to the barrel of the hand-held firearm, the secondary viewing device having:
a first camera retained by, and disposed on a first side of, the housing of the secondary viewing device, disposed substantially adjacent to and in front of the muzzle of the hand-held firearm, and directed in a viewing orientation substantially orthogonal to the longitudinal axis of the barrel of the hand-held firearm for viewing targets lateral to the hand-held firearm; and
a second camera retained by, and disposed on a second side of, the housing of the secondary viewing device, disposed substantially adjacent to and in front of the muzzle of the hand-held firearm, and directed in a viewing orientation substantially orthogonal to the longitudinal axis of the barrel of the hand-held firearm for viewing targets lateral to the hand-held firearm, the viewing orientation of the second camera of a substantially inverse orientation with respect to the viewing orientation of the first camera.

16. (canceled)

17. The improvement according to claim 15, wherein:
the secondary viewing device and the hand-held firearm operably configured to have simultaneous and omnidirectional rotation with one another by a user.

18. The improvement according to claim 15, further comprising:
a display communicatively coupled to the first and second cameras and operably configured to receive a plurality of images corresponding, respectively, to the viewing orientations of both the first and second cameras.

19. The improvement according to claim 15, further comprising
a sleeve defining an opening sized and shaped to receive a user's arm and having an outer surface with a display coupled thereto, the display operably configured to simultaneously display a plurality of images corresponding, respectively, to the viewing orientations of both the first and second cameras.

20. The improvement according to claim 15, wherein:
the housing of the secondary viewing device is removably coupled to the barrel of the hand-held firearm through a tongue-and-grove configuration.
